(19) United States
(12) Patent Application Publication
(10) Pub. No.: US 2021/0355753 A1
(43) Pub. Date: Nov. 18, 2021

(54) ROLLER BLIND WITH HEAT INSULATION FUNCTION

(71) Applicant: Young Kwan KIM, Yongin-si, Gyeonggi-do (KR)

(72) Inventor: Young Kwan KIM, Yongin-si, Gyeonggi-do (KR)

(21) Appl. No.: 16/975,684

(22) PCT Filed: Nov. 28, 2019
(86) PCT No.: PCT/KR2019/016626

§ 371 Date: Aug. 25, 2020

(51) Int. Cl. E06B 9/262; E06B 9/58; E06B 9/42

(52) U.S. Cl. CPC E06B 9/262; E06B 2009/2627; E06B 9/42; E06B 9/58

(57) ABSTRACT

Disclosed is a roller blind with a heat insulation function. The roller blind with a heat insulation function of the present disclosure includes a roller rotatably mounted in a frame, a heat insulation sheet configured to be wound and unwound on the roll, a plurality of tubular sheets attached to one surface of the heat insulation sheet and formed to have openings at both ends thereof, and a pair of rail members provided to extend in a direction in which the heat insulation sheet is unwound so as to block air from moving through the openings at both ends of the plurality of tubular sheets. According to the present disclosure, the roller blind with a heat insulation function is configured to effectively block heat in hot weather or cold in cold weather from being transferred to a room through a window.

### FIELD

The present disclosure relates to a roller blind with a heat insulation function and, more particularly, to a roller blind with a heat insulation function formed in a simple structure and configured to have a heat insulation effect as well as a shading effect.

### BACKGROUND

Curtains, venetian blinds, and roller blinds are representative examples of window shades. Roller blinds have a relatively simple structure and allow a room to remain dim even in the daytime. In addition, roller blinds are made of various materials and have various patterns thereon, and thus are used as an interior decoration. Roller blinds are generally used in the living room of a house.

However, since conventional roller blinds are produced of only one sheet of fabric, such conventional roller blinds only reduce the amount of direct sunlight entering the room, and have little heat insulation effect by which heat in hot weather or cold in cold weather is prevented from being transferred to the room through the window.

In this regard, Korean Patent Application Publication No. 2009-0107593 (hereinafter referred to as “related art 1”) discloses a light-adjustable dual roller blind. The dual roller blind of related art 1 includes a first screen part and a second screen part. The first screen part includes a first screen made of woven aluminum fabric. The second screen part includes a second screen having a predetermined shading rate.

The light-adjustable dual roller blind of related art 1 includes two screens having different shading rates provided inside a frame of the roller blind, such that a user can adjust the amount of light entering a room to a desired level by using the two screens.

However, the light-adjustable dual roller blind of related art 1 can only adjust the amount of light entering the room, and cannot block heat in hot weather and cold in cold weather from being transferred to the room through the window, which is a typical deficiency of conventional roller blinds.

It cannot be said, of course, that the light-adjustable dual roller blind of related art 1 has absolutely no effect in blocking the heat and cold from being transferred to the room. The two screens of related art 1 form a space therebetween (hereinafter referred to as an “in-between space”). Accordingly, the heat and cold in the window may be partially blocked by the in-between space.

However, the in-between space may communicate with the room along the edges of the two screens. Therefore, it can be said that the light-adjustable dual roller blind of related art 1 may have a heat insulation effect due to the in-between space, but the heat insulation effect of the in-between space may be relatively insignificant.

In addition, even to secure the insignificant heat insulation effect, the user has to lower and raise each of the two screens of the light-adjustable dual roller blind of related art 1. Accordingly, twice as much energy may be required to operate the light-adjustable dual roller blind of related art 1 as compared to operating a general roller blind. As a result, the user may feel inconvenience and thus may avoid using the dual roller blind of related art 1.

### SUMMARY

An aspect of the present disclosure is directed to providing a roller blind with a heat insulation function that may effectively block heat in hot weather or cold in cold weather from being transferred to a room through a window, may be easy to use, and may be used as an indoor decoration.

The roller blind with a heat insulation function according to the present disclosure may include: a roll rotatably mounted in a frame; a heat insulation sheet that is wound and unwound on the roll; a plurality of tubular sheets attached to one surface of the heat insulation sheet and formed to have openings at both ends thereof; and a pair of rail members provided to extend in a direction in which the heat insulation sheet is unwound so as to block air from passing through the openings at both ends of the plurality of tubular sheets.

The heat insulation sheet may move up and down while being wound or unwound on the roll.

The pair of rail members may be provided at both left and right sides of the heat insulation sheet.

The openings of the plurality of tubular sheets may be formed at both left and right ends of the plurality of tubular sheets.

Each of the pair of rail members may form a first surface that faces the openings of the plurality of tubular sheets.

Each of the pair of rail members may form a second surface that faces one surface of the heat insulation sheet and a third surface that faces one surface of each of the plurality of tubular sheets, wherein the second surface and the third surface may face each other.

The plurality of tubular sheets may form contact surfaces between each other, and the plurality of tubular sheets may be attached to each other on the contact surfaces.

The contact surfaces of the plurality of tubular sheets may be spaced apart from the heat insulation sheet such that separation spaces are formed between the heat insulation sheet and the plurality of tubular sheets.

The first surface may face openings of the separation spaces.

The heat insulation sheet may move up and down while being wound or unwound on the roll.

A first bar may be provided within an uppermost tubular sheet among the plurality of tubular sheets.

An insertion groove may be formed in an outer surface of the roll along a longitudinal direction.

The first bar may be inserted into the insertion groove.

The roller blind with a heat insulation function may further include a plurality of layered tubular sheets which are attached to the plurality of tubular sheets on the opposite side to the heat insulation sheet and have openings at both ends thereof.

The pair of rail members may block air from moving through the openings at both ends of the plurality of layered tubular sheets.

The heat insulation sheet may move up and down while being wound or unwound on the roll.

A second bar may be provided within a lowermost tubular sheet among the plurality of tubular sheets.

A weight of the second bar may be greater than a sum of a frictional force between the pair of rail members and the heat insulation sheet and a frictional force between the pair of rail members and the plurality of tubular sheets.

According to the present disclosure, as the pair of rail members, which are provided to extend in the direction in which the heat insulation sheet is unwound, block air from moving through the openings at both ends of the plurality of tubular sheets, the roller blind with a heat insulation function may effectively block heat in hot weather or cold in cold weather from being transferred to the room through the window.

Also, as the plurality of the tubular sheets are attached to one surface of the heat insulation sheet, the roller blind with a heat insulation function may be easy to use and may be used as an interior decoration.

### BRIEF DESCRIPTION OF THE DRAWINGS

The foregoing and other aspects, features, and advantages of the invention, as well as the following detailed description of the embodiments, will be better understood when read in conjunction with the accompanying drawings. For the purpose of illustrating the present disclosure, there is shown in the drawings an exemplary embodiment, it being understood, however, that the present disclosure is not intended to be limited to the details shown because various modifications and structural changes may be made therein without departing from the spirit of the present disclosure and within the scope and range of equivalents of the claims. The use of the same reference numerals or symbols in different drawings indicates similar or identical items.

FIG. 1 is an elevation view illustrating a roller blind with a heat insulation function according to an embodiment of the present disclosure being used.

FIG. 2 is a partial exploded perspective view illustrating the roller blind with a heat insulation function of FIG. 1.

FIG. 3 is a partial cross-sectional view illustrating the roller blind with a heat insulation function of FIG. 1.

FIG. 4 is a partial cross-sectional view illustrating the roller blind with a heat insulation function of FIG. 1 being used.

FIG. 5 is a partial cross-sectional view illustrating tubular sheets of a roller blind with a heat insulation function according to another embodiment of the present disclosure.

### DESCRIPTION OF SYMBOLS

1: ROLLER BLIND WITH HEAT INSULATION FUNCTION
10: FRAME
20: ROLL
21: INSERTION GROOVE
30: CORD
40: HEAT INSULATION SHEET
1S: SEPARATION SPACE
50: TUBULAR SHEET
51: HEAT INSULATION SPACE
52: CONTACT SURFACE
2: BUILDING
2W: OPENING
60: RAIL MEMBER
61: FIRST SURFACE
62: SECOND SURFACE
63: THIRD SURFACE
70: FIRST BAR
80: SECOND BAR
90: LAYERED TUBULAR SHEET
91: HEAT INSULATION SPACE

### DETAILED DESCRIPTION

Advantages and features of the present disclosure and methods for achieving them will become apparent from the descriptions of aspects herein below with reference to the accompanying drawings. However, the present disclosure is not limited to the aspects disclosed herein but may be implemented in various different forms. The aspects are provided to make the description of the present disclosure thorough and to fully convey the scope of the present disclosure to those skilled in the art. It is to be noted that the scope of the present disclosure is defined only by the claims.

The shapes, sizes, ratios, angles, the number of elements given in the drawings are merely exemplary, and thus, the present disclosure is not limited to the illustrated details. Like reference numerals designate like elements throughout the specification.

In relation to describing the present disclosure, when the detailed description of the relevant known technology is determined to unnecessarily obscure the gist of the present disclosure, the detailed description may be omitted.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

Hereinafter, preferable exemplary embodiments of the present disclosure will be described in detail referring to the attached drawings. In the following description, known functions or features will be omitted in order to clarify the gist of the present disclosure.

A roller blind with a heat insulation function of the present disclosure may effectively block heat in hot weather or cold in cold weather from being transferred to the room through the window, may be easy to use, and may be used as an interior decoration.

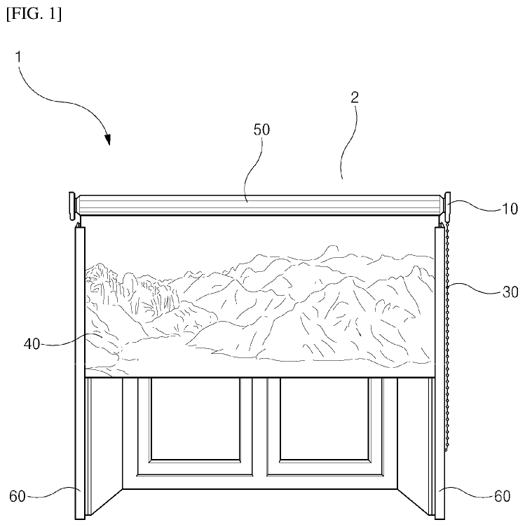

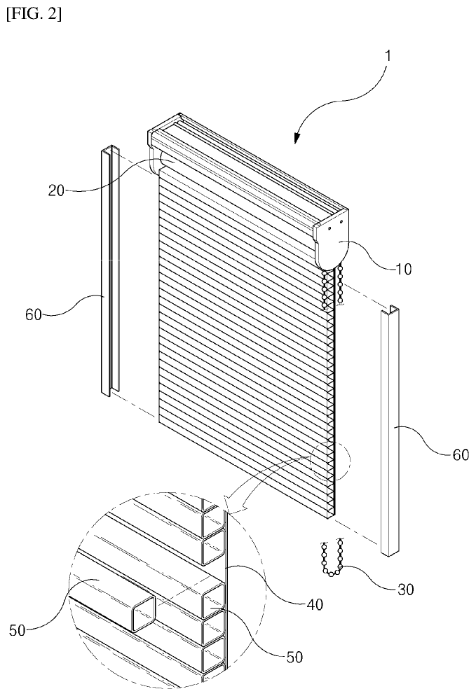

FIG. 1 is an elevation view illustrating a roller blind with a heat insulation function 1 according to an embodiment of the present disclosure being used. FIG. 2 is a partial exploded perspective view illustrating the roller blind with a heat insulation function 1 of FIG. 1.

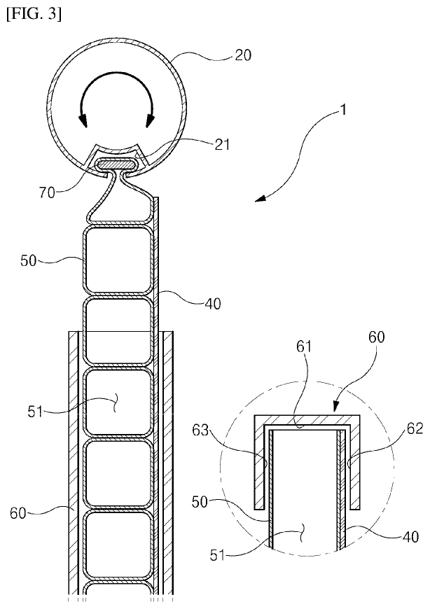

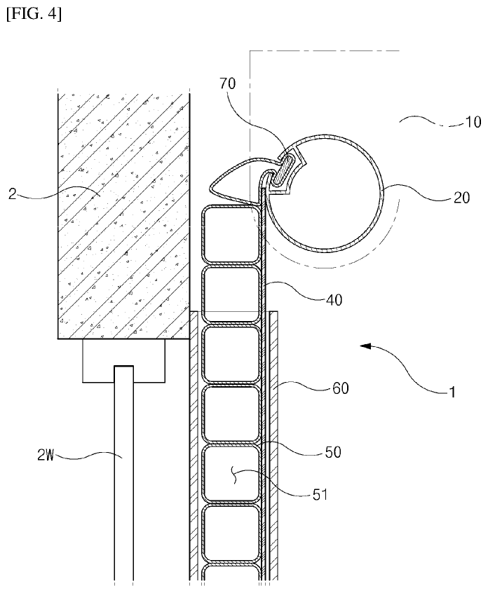

FIG. 3 is a partial cross-sectional view illustrating the roller blind with a heat insulation function 1 of FIG. 1. FIG. 4 is a partial cross-sectional view illustrating the roller blind with a heat insulation function 1 of FIG. 1 being used.

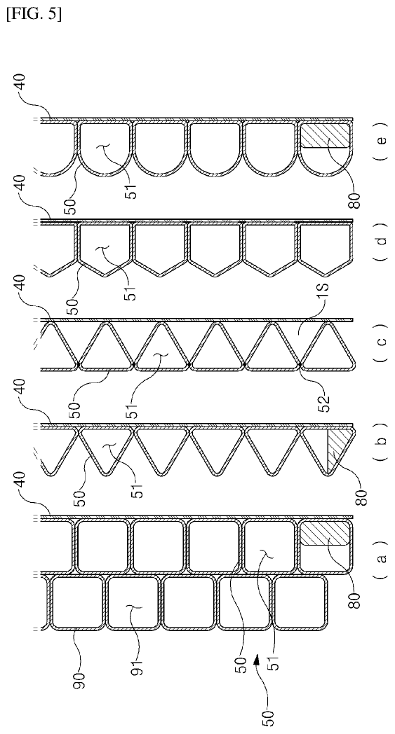

FIG. 5 is a partial cross-sectional view illustrating tubular sheets 50 of a roller blind with a heat insulation function 1 according to another embodiment of the present disclosure.

Hereinafter, for easy understanding of the present disclosure, up and down and left and right directions mentioned in the detailed description will be based on the drawings.

As illustrated in FIGS. 1 to 4, the roller blind with a heat insulation function 1 according to an embodiment of the present disclosure may have a relatively simple structure and have a heat insulation effect as well as a shading effect. The roller blind with a heat insulation function 1 according to an embodiment of the present disclosure may include a frame 10, a roll 20, a cord 30, a heat insulation sheet 40, a plurality of tubular sheets 50, a pair of rail members 60, and a first bar 70.

As illustrated in FIGS. 1 to 4, the frame 10 may be installed on a wall portion above an opening 2W in a building 2. It should be understood that the opening 2W refers to any place at which a window blind can be installed, such as a window, a glass wall, etc. The frame 10 may be installed on a wall portion above the opening 2W or on a ceiling in a room in the building 2.

The frame 10 may rotatably support the roll 20. A rolling bearing may be installed in a rotation shaft of the frame 10.

Although not specifically illustrated, the frame 10 may be installed on a wall portion or on a ceiling by means of a hook and an angle bracket. The hook may be attached to the wall portion or the ceiling by means of a screw. The angle bracket may be screwed to the hook.

A head rail may be formed in the frame 10. The head rail may be inserted into the hook with a clicking sound. When a portion of the hook is pushed by a finger or a screwdriver, the main body of the frame 10 may be released.

As illustrated in FIG. 3, the roll 20 may be formed in a circular pipe shape. The roll 20 may rotate in both directions to wind or unwind the heat insulation sheet 40 and the plurality of tubular sheets 50.

An insertion groove 21 may be formed in an outer surface of the roll 20 along a longitudinal direction. An entrance of the insertion groove 21 may be relatively narrow, and an inner portion of the insertion groove 21 may enlarge in a circumferential direction of the roll 20.

The roll 20 may be rotatably mounted in the frame 10. Each of end portions of the roll 20 may be rotatably mounted in the frame 10. The roll 20 may be rotated in both directions by pulling the cord 30.

The cord 30 may be provided in the form of a bead chain. When a user pulls the cord 30 in either direction, the roll 20 may rotate in either direction.

As illustrated in FIGS. 3 and 4, as the roll 20 rotates in either direction, the heat insulation sheet 40 may be wound or unwound on the roll 20. As the heat insulation sheet 40 is wound or unwound on the roll 20, the heat insulation sheet 40 may move up and down. The heat insulation sheet 40 may be wound on the roll 20 starting from an upper end thereof.

As illustrated in FIG. 1, the heat insulation sheet 40 may be formed in a rectangular shape. One surface of the heat insulation sheet 40 may be exposed to the room. Various images may be printed on the one surface of the heat insulation sheet 40 that is exposed to the room. FIG. 1 illustrates the heat insulation sheet 40 in which a landscape painting is printed on the one surface thereof that is exposed to the room.

The heat insulation sheet 40 may be produced of a heat insulation fabric of which the heat transfer rate is relatively very low. Heat insulation fabric is a well-known technology, as disclosed in Korean Patent Registration Publication No. 1845240 (Environment-friendly coating material for insulating fiber, manufacturing method thereof, and fabric using same). Accordingly, detailed description of the heat insulation fabric will be omitted.

As illustrated in FIGS. 2 and 3, the plurality of tubular sheets 50 may be attached to the other surface of the heat insulation sheet 40. The other surface of the heat insulation sheet 40 to which the plurality of tubular sheets 50 are attached may be a surface that faces the opposite side of the room. Referring to FIG. 3, right-side surfaces of the plurality of tubular sheets 50 may be attached to a left-side surface of the heat insulation sheet 40 by means of an adhesive.

The plurality of tubular sheets 50 may be produced in the form of polygonal pipes. FIGS. 1 to 4 illustrate the plurality of tubular sheets 50 in the form of rectangular pipes.

Each of the plurality of tubular sheets 50 may be produced by attaching one relatively longer edge of an oblong rectangular fabric sheet to the opposite edge thereof. Accordingly, openings may be formed in each of the plurality of tubular sheets 50 at both ends thereof in the longitudinal direction.

As illustrated in FIGS. 3 and 4, a heat insulation space 51 may be formed within each of the plurality of tubular sheets 50. The heat insulation space 51 may communicate with the outside through the openings at both ends of the plurality of tubular sheets 50.

The plurality of tubular sheets 50 may be made of the same material as the heat insulation sheet 40. That is, the plurality of tubular sheets 50 may be, like the heat insulation sheet 40, made of a fabric capable of blocking transfer of heat.

As illustrated in FIG. 2, the heat insulation sheet 40 may move up and down while being wound and unwound on the roll 20, and the openings of the plurality of tubular sheets 50 may be formed at both left and right ends of the plurality of tubular sheets 50. A plurality of tubular sheets 50 that are attached to a single heat insulation sheet 40 may be formed in the same shape.

As illustrated in FIG. 3, the plurality of tubular sheets 50 that are attached to a single heat insulation sheet 40 may come into contact with each other on upper surfaces and lower surfaces thereof. Accordingly, two adjacent tubular sheets 50 may form a contact surface therebetween which is perpendicular to an up-and-down direction.

The plurality of tubular sheets 50 may be kept in contact with each other without being attached to each other on contact surfaces. Accordingly, as illustrated in FIG. 4, when the plurality of tubular sheets 50 and the heat insulation sheet 40 are wound on the roll 20 as the roll 20 rotates, the plurality of tubular sheets 50 that were in contact with each other on the contact surfaces may be separated from each other.

Alternatively, the plurality of tubular sheets 50 may be attached to each other by means of an adhesive at a portion of the contact surfaces or at the entirety of the contact surfaces.

As illustrated in FIG. 3, a first bar 70 may be provided within an uppermost tubular sheet 50 among the plurality of tubular sheets 50. The first bar 70 may be formed to extend in one direction.

The insertion groove 21 may be formed in the outer surface of the roll 20 along the longitudinal direction, and the first bar 70 within the uppermost tubular sheet 50 may be inserted into the insertion groove 21.

Referring to FIG. 3, the first bar 70 may be formed such that a vertical length (i.e., thickness) thereof is smaller than a horizontal length (i.e., width) of the entrance of the insertion groove 21. Accordingly, the first bar 70 may be inserted into the insertion groove 21.

The entrance of the insertion groove 21 may be relatively narrow, and an inner portion of the insertion groove 21 may enlarge in a circumferential direction of the roll 20. Referring to FIG. 3, the first bar 70 may be formed such that a horizontal length thereof is greater than the horizontal length of the entrance of the insertion groove 21. Accordingly, a state in which the first bar 70 is inserted into the insertion groove 21 may be maintained.

As a result, a state in which the uppermost tubular sheet 50 among the plurality of tubular sheets 50 is attached to the roll 20 may be maintained. When the roll 20 rotates clockwise as shown in FIG. 4, the plurality of tubular sheets 50 and the heat insulation sheet 40 may be wound on the roll 20, wherein the uppermost tubular sheet 50 may be wound first among the plurality of tubular sheets 50.

Referring to FIG. 4, as the roll 20 rotates clockwise, the heat insulation sheet 40 and the plurality of tubular sheets 50 may be alternately layered onto the roll 20 in a radial direction of the roll 20.

The plurality of tubular sheets 50 may be made of a fabric material that is easily deformed. Also, each of the plurality of tubular sheets 50 may be formed in a hollow pipe shape. Accordingly, as the plurality of tubular sheets 50 are wound on the roll 20, the plurality of tubular sheets 50 may be deformed to be flat by the heat insulation sheet 40 covering the plurality of tubular sheets 50.

As illustrated in FIGS. 1 to 4, the pair of rail members 60 may be provided at both left and right sides of the heat insulation sheet 40. The pair of rail members 60 may be formed to extend in a direction in which the heat insulation sheet 40 is unwound.

As illustrated in FIG. 2, the openings of the plurality of tubular sheets 50 may be formed at both left and right ends of the plurality of tubular sheets 50. As illustrated in FIG. 3, the rail members 60 may form a first surface 61 that faces the openings at both ends of the plurality of tubular sheets 50.

The uppermost tubular sheet 50 among the plurality of tubular sheets 50 may be positioned lower than an upper end of the rail members 60 until right before the plurality of tubular sheets 50 are wound on the roll 20. Accordingly, until right before the uppermost tubular sheet 50 among the plurality of tubular sheets 50 is wound on the roll 20, the openings at both ends of the plurality of tubular sheets 50 may face the first surface 60.

As illustrated in FIGS. 3 and 4, the heat insulation space 51 may be formed within each of the plurality of tubular sheets 50. The heat insulation space 51 may communicate with the outside through the openings at both ends of the plurality of tubular sheets 50.

A small gap (hereinafter referred to as a “first gap”) may be formed between the first surface 61 and the openings of the plurality of tubular sheets 50. The first gap may be a gap of 0 to 3 millimeters. Here, a gap of 0 millimeters may mean that the first surface 61 and a rim of the openings are in contact with each other.

Movement of air between the heat insulation space 51 and the outside may occur only through the first gap. The first gap may be sufficiently small as compared to a width, a length, and a height of the heat insulation space 51.

As illustrated in FIG. 3, the rail members 60 may form a second surface 62 and a third surface 63.

The second surface 62 may face one surface of the heat insulation sheet 40. As illustrated in the expanded view of FIG. 3, the second surface 62 may face a right-side surface of the heat insulation sheet 40. The expanded view of FIG. 3 illustrates a horizontal cross section of the heat insulation sheet 40, one tubular sheet 50, and one rail member 60.

A small gap (hereinafter referred to as a “second gap”) may be formed between the second surface 62 and the one surface of the heat insulation sheet 40. The second gap may be a gap of 0 to 3 millimeters. Here, a gap of 0 millimeters may mean that the second surface 62 and the one surface of the heat insulation sheet 40 are in contact with each other.

Movement of air between the heat insulation space 51 and the outside may occur through the second gap. The second gap may be significantly small as compared to the width, the length, and the height of the heat insulation space 51.

The third surface 63 may face one surface of each of the plurality of tubular sheets 50. As illustrated in the expanded view of FIG. 3, the third surface 63 may face left-side surfaces of the plurality of tubular sheets 50.

A small gap (hereinafter referred to as a “third gap”) may be formed between the third surface 63 and the one surface of each of the plurality of tubular sheets 50. The third gap may be a gap of 0 to 3 millimeters. Here, a gap of 0 millimeters may mean that the third surface 63 and the one surface of each of the plurality of tubular sheets 50 are in contact with each other.

Movement of air between the heat insulation space 51 and the outside may occur through the third gap. The third gap may be sufficiently small as compared to the width, the length, and the height of the heat insulation space 51.

As illustrated in FIG. 3, each of the second surface 62 and the third surface 63 may form a right angle with the first surface 61. The second surface 62 and the third surface 63 may be formed to face each other. That is, the first surface 61, the second surface 62, and the third surface 63 may form a square bracket shape.

Even when air moves through the first gap, the air has to pass through the second gap or the third gap. The first surface 61, the second surface 62, and the third surface 63 of the rail members 60 may block air from moving through the openings at both ends of the plurality of tubular sheets 50.

Movement of air inside the building 2 may be limited. Even when a vigorous movement of air occurs through, for example, a fan, an air conditioner, or a fan heater, it may be difficult for air to pass through the first gap and the second gap or the third gap.

Accordingly, the heat insulation space 51 within the plurality of tubular sheets 50 may literally act as a heat insulation space in which the heat transfer rate is relatively very low.

As illustrated in FIG. 4, the window and the room may be partitioned by the heat insulation sheet 40 and the plurality of tubular sheets 50. That is, an isolated space that is isolated from the room may be formed between the plurality of tubular sheets 50 and the window.

An upper portion and a lower portion of the plurality of tubular sheets 50 may be spaced apart from the wall of the building 2 by some millimeters. However, since the space of some millimeters is sufficiently small as compared to a width and a height of the window, the isolated space may be regarded as a space isolated from the room.

The isolated space and the room in the building 2 may be partitioned by the plurality of tubular sheets 50. The plurality of tubular sheets 50 that are attached to a single heat insulation sheet 40 may come into contact with each other on the upper surfaces and the lower surfaces thereof. The plurality of tubular sheets 50 may form the heat insulation space 51 therein. Accordingly, the isolated space and the room in the building 2 may be partitioned by the heat insulation space 51.

As a result, the window and the room in the building 2 may be partitioned by the isolated space and the heat insulation space 51. Accordingly, only after the air in the room in the building 2 passes through the isolated space and the heat insulation space 51, heat exchange may occur between the air in the room and the heat or cold in the window. Accordingly, it may be very difficult for the heat or cold in the window to be transferred to the room in the building 2.

Also, the heat insulation sheet 40 and the plurality of tubular sheets 50 may be made of a heat insulation fabric of which the heat transfer rate is relatively very low.

The light-adjustable dual roller blind of related art 1 can only adjust the amount of light entering the room, and cannot prevent heat in hot weather and cold in cold weather from being transferred to the room through the window, which is a typical deficiency of conventional roller blinds.

It cannot be said, of course, that the light-adjustable dual roller blind of related art 1 has absolutely no effect in blocking the heat and cold from being transferred to the room. The two screens of related art 1 form a space therebetween (hereinafter referred to as “in-between space”). Accordingly, the heat and cold in the window may be partially blocked by the in-between space.

However, the in-between space may communicate with the room along the edges of the two screens. Therefore, it can be said that the light-adjustable dual roller blind of related art 1 may have a heat insulation effect due to the in-between space, but the heat insulation effect of the in-between space may be relatively insignificant.

The roller blind with a heat insulation function 1, on the other hand, is characterized in that the heat insulation sheet 40 and the plurality of tubular sheets 50 may be made of a heat insulation material, and the isolated space and the heat insulation space 51 may be formed between the window and the room in the building 2, to thereby resolve said deficiency of conventional roller blinds.

In addition, in related art 1, even to secure the insignificant heat insulation effect, the user has to lower and raise each of the two screens of the light-adjustable dual roller blind. Accordingly, twice as much energy may be required to operate the light-adjustable dual roller blind of related art 1 as compared to operating a general roller blind. As a result, the user may feel inconvenience and thus avoid using the dual roller blind of related art 1.

The roller blind with a heat insulation function 1 of the present disclosure is characterized in that the isolated space and the heat insulation space 51 may be simultaneously formed between the window and the room in the building 2 through a simple motion of pulling the cord 30, to thereby resolve said deficiency of conventional roller blinds.

As shown in FIG. 5, the plurality of tubular sheets 50 may be produced in the form of polygonal pipes.

As illustrated in (a) in FIG. 5, each of the plurality of tubular sheets 50 may be formed in a rectangular pipe shape. As illustrated in (b) and (c) in FIG. 5, each of the plurality of tubular sheets 50 may be formed in a triangular pipe shape.

As shown in (d) in FIG. 5, each of the plurality of tubular sheets 50 may be formed in a pentagonal pipe shape. As shown in (e) in FIG. 5, each of the plurality of tubular sheets 50 may be formed in a semi-circular pipe shape.

Each of the plurality of tubular sheets 50 may be produced by attaching one relatively longer edge of an oblong rectangular fabric sheet to the opposite edge thereof.

Various polygonal shapes of the plurality of tubular sheets 50 may be maintained by folding a flat sheet and then pressing the folded sheet using a high-temperature press. A plurality of tubular sheets 50 that are attached to a single heat insulation sheet 40 may be formed in the same shape.

As illustrated in (a) in FIG. 5, a plurality of layered tubular sheets 90 may be attached to the plurality of tubular sheets 50 on the opposite side of the heat insulation sheet 40.

The plurality of layered tubular sheets 90 may be produced in the form of polygonal pipes. (a) in FIG. 5 illustrates the plurality of layered tubular sheets 90 in the form of rectangular pipes.

Each of the plurality of layered tubular sheets 90 may be produced by attaching one relatively longer edge of an oblong rectangular fabric sheet to the opposite edge thereof. Accordingly, openings may be formed in each of the plurality of layered tubular sheets 90 at both ends thereof in the longitudinal direction.

As illustrated in (a) in FIG. 5, a heat insulation space 91 may be formed within each of the plurality of layered tubular sheets 90. The heat insulation space 91 may communicate with the outside through the openings at both ends of the plurality of layered tubular sheets 90.

The plurality of layered tubular sheets 90 may be made of the same material as the heat insulation sheet 40. That is, the plurality of layered tubular sheets 90 may be, like the heat insulation sheet 40, made of a fabric capable of blocking transfer of heat.

The openings of the plurality of layered tubular sheets 90 may be formed at both left and right ends of the plurality of layered tubular sheets 90. A plurality of layered tubular sheets 90 that are attached to a single heat insulation sheet 40 may be formed in the same shape.

The plurality of layered tubular sheets 90 that are attached to a single heat insulation sheet 40 may come into contact with each other on upper surfaces and lower surfaces thereof. Accordingly, two adjacent layered tubular sheets 90 may form a contact surface therebetween which is perpendicular to an up-and-down direction.

The plurality of layered tubular sheets 90 may be kept in contact with each other without being attached to each other on contact surfaces. Accordingly, when the plurality of layered tubular sheets 90 and the heat insulation sheet 40 are wound on the roll 20 as the roll 20 rotates, the plurality of layered tubular sheets 90 that were in contact with each other on the contact surfaces may be separated from each other.

Alternatively, the plurality of layered tubular sheets 90 may be attached to each other by means of an adhesive at a portion of the contact surfaces or at the entirety of the contact surfaces.

As the roll 20 rotates, the heat insulation sheet 40, the plurality of tubular sheets 50, and the plurality of layered tubular sheets 90 may be alternately layered onto the roll 20 in the radial direction of the roll 20.

The plurality of layered tubular sheets 90 may be made of a fabric material that is easily deformed. Also, each of the plurality of layered tubular sheets 90 may form a hollow pipe shape. Accordingly, as the plurality of layered tubular sheets 90 are wound on the roll 20, the plurality of layered tubular sheets 90 may be deformed to be flat by the heat insulation sheet 40 covering the plurality of layered tubular sheets 90.

The openings of the plurality of layered tubular sheets 90 may be formed at both left and right ends of the plurality of layered tubular sheets 90. The first surface 61 of the rail members 60 may face the openings at both ends of the layered tubular sheets 90. That is, the pair of rail members 60 may block air from moving through the openings at both ends of the plurality of layered tubular sheets 90.

Thus, when the plurality of layered tubular sheets 90 are attached to the plurality of tubular sheets 50 on the opposite side of the heat insulation sheet 40, the isolated space and a pair of heat insulation spaces 51 and 91 may be formed between the window and the room in the building 2. As a result, it may be very difficult for the heat or cold in the window to be transferred to the room through the window.

As illustrated in FIG. 5, a second bar 80 may be provided within a lowermost tubular sheet 50 among the plurality of tubular sheets 50.

When the user pulls the cord 30 to lower the heat insulation seat 40 and the plurality of tubular sheets 50, friction (hereinafter referred to as “descending friction”) may occur between the plurality of tubular sheets 50 and the first surface 61, the second surface 62, and the third surface 62 of the rail members 60, and between the heat insulation seat 40 and the first surface 61, the second surface 62, and the third surface 62 of the rail members 60.

When the descending friction is relatively high, it is likely that the heat insulation seat 40 and the plurality of tubular sheets 50 will not be appropriately lowered even when the user pulls the cord 30.

A weight of the second bar 80 may be sufficiently greater than a sum of a frictional force between the rail members 60 and the heat insulation sheet 40 and a frictional force between the rail members 60 and the plurality of tubular sheets 50.

Accordingly, when the second bar 80 is provided within the lowermost tubular sheet 50 among the plurality of tubular sheets 50, the user may be able to lower the heat insulation sheet 40 and the plurality of tubular sheets 50 by pulling the cord 30, even when the friction occurs between the plurality of tubular sheets 50 and the first surface 61, the second surface 62, and the third surface 62 of the rail members 60, and between the heat insulation sheet 40 and the first surface 61, the second surface 62, and the third surface 62 of the rail members 60.

A center of gravity of the second bar 80 may be positioned not in the middle of the plurality of tubular sheets 50, but to be relatively closer to the heat insulation sheet 40. The center of gravity of the second bar 80 that is positioned to be relatively closer to the heat insulation sheet 40 may allow the heat insulation sheet 40 to be relatively tightly stretched in a vertical direction.

As illustrated in (c) in FIG. 5, a contact surface 52 between the plurality of tubular sheets 50 may be spaced apart from the heat insulation sheet 40 in a horizontal direction such that a space (hereinafter referred to as “separation space 1S”) is formed between the heat insulation sheet 40 and the plurality of tubular sheets 50.

Separation spaces 1S may be formed along a longitudinal direction of the plurality of tubular sheets 50. The first surface 61 of the rail members 60 may face openings of the separation spaces 1S at both ends thereof. That is, the pair of rail members 60 may block air from moving through the openings at both ends of the separation spaces 1S.

Thus, when the separation spaces 1S are formed between the heat insulation sheet 40 and the plurality of tubular sheets 50, the isolated space, the heat insulation space 51, and the separation spaces 1S may be formed between the window and the room in the building 2. As a result, it may be very difficult for the heat or cold in the window to be transferred to the room through the window.

According to the present disclosure, as the pair of rail members 60, which are provided to extend in the direction in which the heat insulation sheet is unwound, block air from moving through the openings at both ends of the plurality of tubular sheets 50, the roller blind with a heat insulation function 1 may effectively block heat in hot weather or cold in cold weather from being transferred to the room through the window.

Also, as the plurality of the tubular sheets 50 are attached to one surface of the heat insulation sheet 40, the roller blind with a heat insulation function 1 may be easy to use and may be used as an interior decoration.

While specific exemplary embodiments of the present disclosure are described and illustrated above, it would be obvious to those skilled in the art that various modifications and variations thereto can be made within the spirit and scope of the present disclosure. Accordingly, such modifications or variations are not to be regarded as a departure from the spirit or scope of the present disclosure, and it is intended that the present disclosure cover the modifications and variations of the present disclosure provided they come within the scope of the appended claims and their equivalents.

### INDUSTRIAL APPLICABILITY

According to the roller blind with a heat insulation function of the present disclosure, as a pair of rail members, which are provided to extend in the direction in which the heat insulation sheet is unwound, block air from moving through the openings at both ends of the plurality of tubular sheets, heat in hot weather or cold in cold weather may be effectively blocked from being transferred to the room through the window. In this regard, the roller blind with a heat insulation function of the present disclosure overcomes the limits of existing technology, and there is thus sufficient possibility not only of the use of the related technology but also of the actual sale of apparatuses to which the related technology is applied. In addition, the present disclosure can be obviously and practically implemented by those skilled in the art. Therefore, the present disclosure is industrially applicable.

What is claimed is:

1. A roller blind with a heat insulation function, comprising:
a roll rotatably mounted in a frame;
a heat insulation sheet configured to be wound and unwound on the roll;
a plurality of tubular sheets attached to one surface of the heat insulation sheet, each tubular sheet having openings at both ends thereof; and
a pair of rail members provided to extend in a direction in which the heat insulation sheet is unwound so as to block air from moving through the openings at both ends of the plurality of tubular sheets.

2. The roller blind with a heat insulation function of claim 1,
wherein the heat insulation sheet moves up and down while being wound and unwound on the roll,
the pair of rail members are provided at both left and right sides of the heat insulation sheet, and
the openings of the plurality of tubular sheets are formed at both left and right ends of the plurality of tubular sheets.

3. The roller blind with a heat insulation function of claim 1, wherein each of the pair of rail members forms a first surface that faces the openings of the plurality of tubular sheets.

4. The roller blind with a heat insulation function of claim 3, wherein each of the pair of rail members forms a second surface that faces one surface of the heat insulation sheet and a third surface that faces one surface of each of the plurality of tubular sheets,
wherein the second surface and the third surface face each other.

5. The roller blind with a heat insulation function of claim 3, wherein the plurality of tubular sheets form contact surfaces between each other,
wherein the plurality of tubular sheets are attached to each other on the contact surfaces.

6. The roller blind with a heat insulation function of claim 5, wherein the contact surfaces are spaced apart from the heat insulation sheet such that separation spaces are formed between the heat insulation sheet and the plurality of tubular sheets.

7. The roller blind with a heat insulation function of claim 6, wherein the first surface faces openings of the separation spaces.

8. The roller blind with a heat insulation function of claim 1,
wherein the heat insulation sheet moves up and down while being wound and unwound on the roll,
a first bar is provided within an uppermost tubular sheet among the plurality of tubular sheets,
an insertion groove is formed in an outer surface of the roll along a longitudinal direction, and
the first bar is inserted into the insertion groove.

9. The roller blind with a heat insulation function of claim 1, further comprising a plurality of layered tubular sheets attached to the plurality of tubular sheets on the opposite side of the heat insulation sheet, each layered tubular sheet having openings at both ends thereof,
wherein the pair of rail members block air from moving through the openings at both ends of the plurality of layered tubular sheets.

10. The roller blind with a heat insulation function of claim 1,
wherein the heat insulation sheet moves up and down while being wound and unwound on the roll,
a second bar is provided within a lowermost tubular sheet among the plurality of tubular sheets, and
a weight of the second bar is greater than a sum of a frictional force between the pair of rail members and the heat insulation sheet and a frictional force between the pair of rail members and the plurality of tubular sheets.
